(19) United States
(12) Patent Application Publication
(10) Pub. No.: US 2010/0214872 A1
(43) Pub. Date: Aug. 26, 2010

(54) Ultrasonic Sensor Having Time-Variable Sensitivity Threshold Values

(76) Inventors: Dirk Schmid, Simmozheim (DE); Petko Faber, Renningen (DE)

Correspondence Address: KENYON & KENYON LLP, ONE BROADWAY, NEW YORK, NY, 10004, US

(21) Appl. No.: 12/086,664

(22) PCT Filed: Nov. 16, 2006
(86) PCT No.: PCT/EP2006/068585

§ 371 Date: May 7, 2010

(30) Foreign Application Priority Data
Dec. 15, 2005 (DE) 102005059907.9

(51) Int. Cl. G01S 15/08; G01S 15/93

(52) U.S. Cl. 367/98

(57) ABSTRACT

An ultrasonic sensor is described, in which a time curve for the sensitivity is specified via threshold values which are assigned to individual interpolation points. The position in time of the interpolation points for the ultrasonic sensor is variable.

### FIELD OF THE INVENTION

The present invention is directed to an ultrasonic sensor.

### BACKGROUND INFORMATION

A distance sensor device which is used, in particular, as a component of a parking or reversing aid for a motor vehicle is discussed in German patent document DE 199 63 755 A1. The distance sensor device includes one or more distance sensors and a control unit assigned to the distance sensors for activating the one or more distance sensors over a particular signal line. At least one of the distance sensors has two different operating modes. It is possible to switch between the operating modes by varying a time period and/or an amplitude of a drive pulse of the distance sensor control unit. In particular, microwave sensors used have multiple operating modes, while ultrasonic sensors used have only one operating mode.

A method for varying a reception threshold value for detecting a reflected echo over the reception period is also discussed in European patent document EP 925 765 B1. To describe the reception characteristic, threshold values are specified for certain periods of time. These periods of time are described by interpolation points. The period of time relates to the propagation time of the reflected ultrasonic signal and is therefore in direct relation to the distance covered by the reflected signal from the object on which is was reflected to the ultrasonic sensor.

### SUMMARY OF THE INVENTION

The ultrasonic sensor according to the exemplary embodiments and/or exemplary methods of the present invention and the ultrasonic measurement method according to the present invention, having the features of the subordinate claims, have the advantage over the related art that the position in time of the interpolation points which are used to describe the reception characteristic of the ultrasonic sensor are varied relative to a stationary reference mark. This makes it possible to adjust the reception characteristic of the ultrasonic sensor. The reception characteristic is thus easily adjustable by varying the position of the interpolation points as a function of the conditions under which the sensor is used, for example the environmental conditions, or as a function of a measurement method used. It is therefore possible to easily adjust the sensitivity of the ultrasonic sensor. In particular, this also minimizes the volume of data to the transmitted to the ultrasonic sensor to control the latter. It is therefore possible, for example, to cover different ranges using a single ultrasonic sensor by moving the interpolation points. It is also possible to produce an ultrasonic sensor which has a measurement mode which is compatible with a sensor previously used. The sensor may also have a further, improved measurement mode. This makes it possible to easily establish compatibility with an older ultrasonic system, while the same sensor may also be used in a newer measurement system. It is also possible to implement different measurement methods, for example an individual measurement using direct echo evaluation, a cross-echo measurement or an interconnection of different sensors to form a joint measurement, the position in time of the interpolation points being adjusted accordingly. The assignment of interpolation points to a position in time is equivalent to the assignment to a certain distance value in relation to an obstacle.

The measures described in the subclaims allow for advantageous refinements and improvements of the ultrasonic sensor specified in Claim 1 and the ultrasonic measurement method specified in the other independent claim. It is particularly advantageous to also select different threshold values for different positions in time of the interpolation points. This enables the sensitivity adjustment to be adjusted even better to the obstacle detection requirements, if necessary.

It is furthermore advantageous to switch the positions in time of the interpolation points between at least one first and one second state. This makes it possible to achieve other positions of the interpolation points and thus additional sensitivity of the sensor solely by transmitting a switchover command.

It is also advantageous to increase the time distance between the positions in time of the interpolation points in the first and the second states. By doing this, a longer period of time and thus a greater range may be covered using the same number of interpolation points. A memory, which is provided for storing the relevant data of the interpolation points, therefore does not have to be enlarged to accommodate the ability to switch the range.

It is also advantageous to provide a non-volatile memory in which the positions in time of the interpolation points and the threshold values are stored. As a result, these values are always available in the ultrasonic sensor, even after the vehicle is turned off, and they do not have to be retransmitted to the ultrasonic sensor each time the latter is activated.

It is also advantageous to relate the position in time of the interpolation points to a stationary time mark upon or at the end of a signal transmission. This time may be stored separately for each interpolation point, so that a time reference may be easily established for the measurement interval in question.

It is particularly advantageous to use an ultrasonic sensor according to the present invention in a motor vehicle. During parking operations, in particular, different ranges are required for measuring parking spaces and for the actual parking operation. Climatic conditions, such as snow or rain, may also make it necessary to adjust the sensitivity of the ultrasonic sensor. However, since even minor collisions with other vehicles may cause serious damage, a distance to obstacles must be reliably displayed to the driver.

In particular, it is possible to easily vary the position in time of the interpolation points via a control signal transmitted to the ultrasonic sensor. This control signal may be used either to switch the position in time of the interpolation points, or, in a further specific embodiment, also to program the interpolation points. Programming may be particularly easily implemented by transmitting the time intervals of the interpolation points in relation to each other to the ultrasonic sensor; if necessary, the threshold values assigned to the interpolation points may themselves be easily transmitted. For this purpose, a data bus system which connects the individual ultrasonic sensors to a control unit may be advantageously utilized.

Exemplary embodiments of the present invention are illustrated in the drawings and explained in greater detail in the following description.

### BRIEF DESCRIPTION OF THE DRAWINGS

FIG. 1 shows a schematic view of multiple ultrasonic sensors of a distance measurement unit in a vehicle.

FIG. 2 shows a side view of the vehicle for illustrating the different ranges.

FIG. 3 shows exemplary embodiments of control signals for varying, in particular the position in time of the interpolation points, according to the present invention.

FIG. 4 shows an exemplary embodiment of the sensitivity of the ultrasonic sensor, plotted over time, showing the individual interpolation points and varying the position of the interpolation points according to the present invention.

FIG. 5 shows an exemplary embodiment of the sensitivity of the ultrasonic sensor, plotted over time, showing the individual interpolation points and varying the position of the interpolation points according to the present invention.

FIG. 6 shows an exemplary embodiment of the sensitivity of the ultrasonic sensor, plotted over time, showing the individual interpolation points and varying the position of the interpolation points according to the present invention.

FIG. 7 shows an exemplary embodiment of the sensitivity of the ultrasonic sensor, plotted over time, showing the individual interpolation points and varying the position of the interpolation points according to the present invention.

### DETAILED DESCRIPTION

The ultrasonic sensor according to the present invention may be used, in particular, in motor vehicles. In this regard, it is used primarily to detect obstacles in the surroundings within a close range of approximately up to five meters.

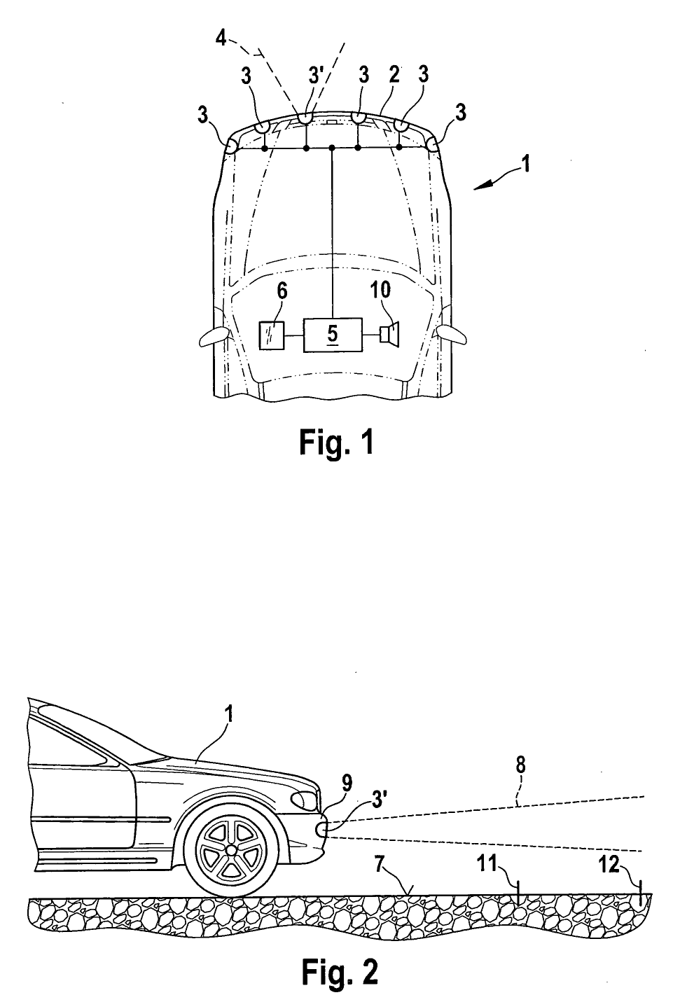

FIG. 1 shows a schematic view of a motor vehicle 1 in which ultrasonic sensors 3 designed according to the present invention are situated at a front end 2 and, if necessary, also in the left and right corners. In the case of one of ultrasonic sensors 3′ situated at front 2 of the vehicle, a monitoring range 4 of the ultrasonic sensor is indicated. As a result of obstacles in a monitoring range of one of the ultrasonic sensors, a transmitted ultrasonic signal is reflected from the obstacle to the ultrasonic sensor (direct-echo measurement) or to another ultrasonic sensor (cross-echo measurement). The distance to the obstacle may be determined from the propagation time of the ultrasonic signal, taking into account the sonic velocity. For this purpose, the received measured data are forwarded from ultrasonic sensors 3, 3′ to a control unit 5. Control unit 5 processes the received data and, upon exceeding a preset distance, outputs a warning to a driver of vehicle 1 via a display unit 6 and/or via an acoustic output unit 10. Control unit 5 is also used to activate ultrasonic sensors 3, 3′ and, if necessary, to adjust their measurements to each other. Control unit 5 is also used to specify the sensitivity of ultrasonic sensors 3, 3′.

FIG. 2 shows a side view of vehicle 1, it being apparent in the illustration according to FIG. 2 that ultrasonic sensor 3′ is mounted on a bumper 9 of the vehicle. The vehicle is moving over a surface 7. FIG. 2 shows a central area 8 of the ultrasonic signals which are emitted by ultrasonic sensor 3′. Furthermore, the ultrasonic waves may also emerge outside this central area of the ultrasonic beam and result in reflections. For example, ultrasonic waves may also be reflected from surface 7. In a first setting, a sensitivity and, in particular, a duration of a reception of reflected signals may be selected in such a way that only obstacles up to a first distance mark 11 are detected. The detection period is selected in such a way that the maximum propagation time of the ultrasonic signal from ultrasonic sensor 3′ to an obstacle and back corresponds to the period of time it takes for a sound signal to cover the distance between ultrasonic sensor 3′ and first distance mark 11. In a further specific embodiment, the ultrasonic sensor may be set in such a way that distance measurements are possible up to a second distance mark 12. First distance mark 11′ may be located at a distance of, for example, over 2.5 meters from the vehicle. Second distance mark 12 may be located at a distance of, for example, 5 meters from the vehicle. The first distance mark may be selected in such a way that it corresponds to the maximum range of existing sensors, while second distance mark 12 corresponds to a measurement distance of an enhanced ultrasonic sensor. Due to the fact that the enhanced ultrasonic sensor is switchable between the two distance marks 11, 12, the sensor may also be used in conjunction with an existing sensor generation without having to make mechanical alterations to the ultrasonic sensor itself.

Three different commands may be provided for controlling the ultrasonic sensors. A first control signal 21, which is transmitted from control unit 5 to the ultrasonic sensors, includes a data header 13 which communicates to the sensor whether it is to transmit or receive. This may be, for example, a preset sequence of high/low digital signals. An appropriate signal is subsequently transmitted to the sensor by control unit 5 in a data part 14 at the beginning and end of the transmission.

A second control signal 22 is designed in such a way that a data header 13′ is encoded in such a way that the sensor is switched to a receiving state 15 following transmission of the relevant header data. The sensor then listens for received ultrasonic signals and transmits a signal to control unit 5 if the threshold value specified for a corresponding point in time is exceeded by the envelope curve of a received ultrasonic signal.

A third control signal 23 includes an extended data header 16. A longer data header 16 is selected, since third control signal 23 is transmitted far less frequently during a measurement than is the transmit or receive command. Third control signal 23 is used to query the status of the ultrasonic sensor and to switch the mode of the ultrasonic sensor. In this case, a switchover is made between a first state, in which the interpolation points have a first position in time for the threshold values for detecting a received signal, and a second state, in which these interpolation points change their positions in time in relation to the first state. A second data header 17 informs the ultrasonic sensor whether a status query or a change in mode will take place. In the case of a possible mode switch, this is followed by the control data in a data part 18. In a further specific embodiment of the present invention, a parameterization of the interpolation points may be carried out via third control signal 23. This makes it possible to specify a position in time and/or a specific threshold value for each interpolation point. The ultrasonic sensor is notified in second data header 17 of whether parameterization should take place. The parameterization data is transmitted to the ultrasonic sensor in data part 18. If multiple ultrasonic sensors are connected to control unit 5, it is possible, in a first specific embodiment, to address all sensors simultaneously. However, in an exemplary embodiment, data headers 13, 13′, 16 have an addressing function which may be used to address a specific sensor.

The present measurement mode of the ultrasonic sensor, i.e., the present position in time of the interpolation points or the threshold values assigned to the interpolation points, is transmittable to the control unit via the status query using third control signal 23. It is therefore possible, on the one hand, to store this assignment for the different modes in control unit 5 in encoded form. In a further specific embodiment, however, the individual values are also transmittable to control unit 5. In the case of the status query, it is also possible to additionally transmit error messages on the status of the ultrasonic sensor.

To prevent a complete failure of the distance measurement, for example after a sudden voltage collapse or a data transmission error, basic values for the position in time of the interpolation points and for the threshold values may be stored in the ultrasonic sensors. Should it be determined during data transmission, for example via a parity bit query, that the transmitted data is invalid, the ultrasonic sensor may be switched to a standard operating mode and the interpolation points stored in the sensor, including their threshold values, used for a measurement. This makes it possible to measure the distances even the first time the sensor is used, without prior parameterization or if the sensitivity parameters stored in the ultrasonic sensor are lost.

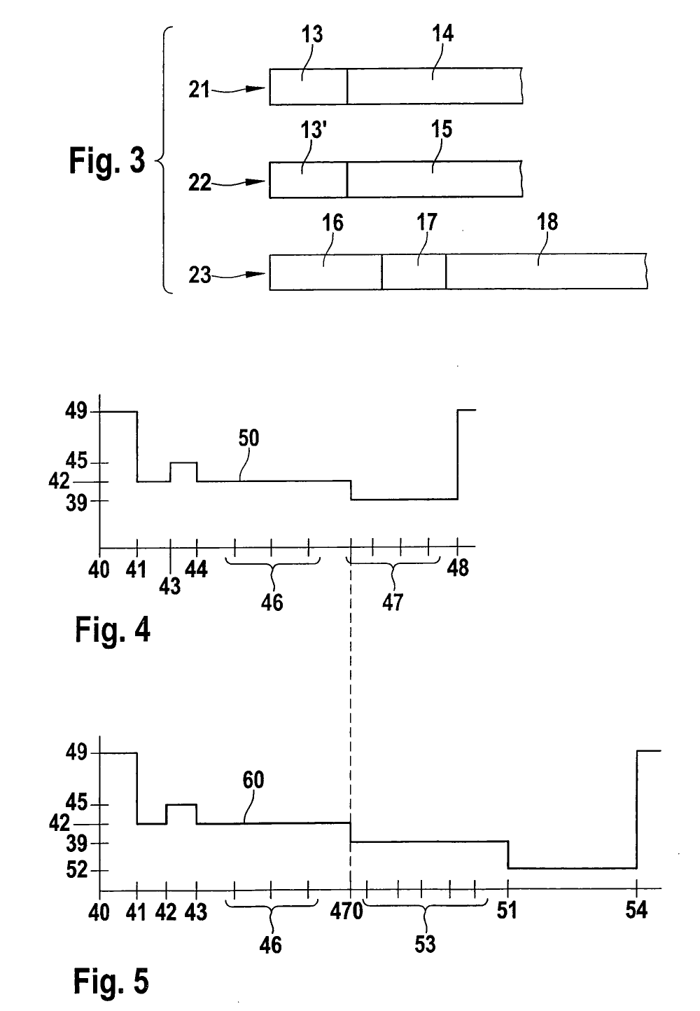

Ultrasonic sensors in a further development stage may be configured so that they are able to read out the control signals shown in FIG. 3 at different data transmission frequencies. For example, it is possible for the data headers to be transmitted to the ultrasonic sensor at a lower frequency, i.e., having a greater bit spacing. If control unit 5 determines during the status query that an enhanced ultrasonic sensor is present, it is possible to subsequently switch to a higher frequency, at which the bit spacing is reduced, for parameterization purposes. This enables the parameter data to be transmitted to the ultrasonic sensor at a higher speed. For example, the interval between two bit signals may be reduced from approximately 2 ms to 0.3 ms.

FIGS. 4 through 7 show the threshold value curve for detecting a received ultrasonic signal over time. In each of FIGS. 4 through 7, the threshold value is plotted on the Y axis. The threshold value is the value which must be exceeded by the maximum of an envelope curve of a received ultrasonic signal so that a detection of a received signal is positively transmittable to control unit 5 at the appropriate point in time. In each case, the time is plotted on the X axis. The end of the transmission activity of the ultrasonic sensor is set, in each case, as zero point 40 for the time axis. A threshold value 49 is subsequently set very high, so that a dead time is specified in which no receive signals are detected. This dead time is used to avoid errors due to vibration decay in the transmit element of the ultrasonic sensor, in principle a piezoelectric element. The zero point is the first interpolation point, starting at which high value 49, which is also not exceeded by the decay vibration, is to be exceeded as the threshold value. This value remains valid up to a first interpolation point 41.

The interpolation point curve is first explained below on the basis of FIG. 4, which shows a curve 50 of a threshold value. After first interpolation point 41, the threshold value drops to a first working value 42. This value remains valid up to a second interpolation point 43, the threshold value being briefly raised up to a fourth interpolation point 44 to avoid errors due to possible bottom echoes. The position in time of the third and fourth interpolation points is selected in such a way that reflections from surface 7 are receivable at the ultrasonic sensor during the relevant period of time. By raising the threshold value to a second working value 45, these reflections are unable to result in a detection error due to the relatively poor reflection on what is, in principle, a smooth bottom surface. Additional interpolation points 46 are subsequently provided, to which first working value 42 in each case is again assigned. This is followed by further interpolation points 47, to which a second, lower working value 39 is assigned, which is somewhat lower so that signals reflected at a greater distance are also detectable. In a further specific embodiment, the interpolation points may each also be assigned different working values. The measurement interval ends at a termination 48.

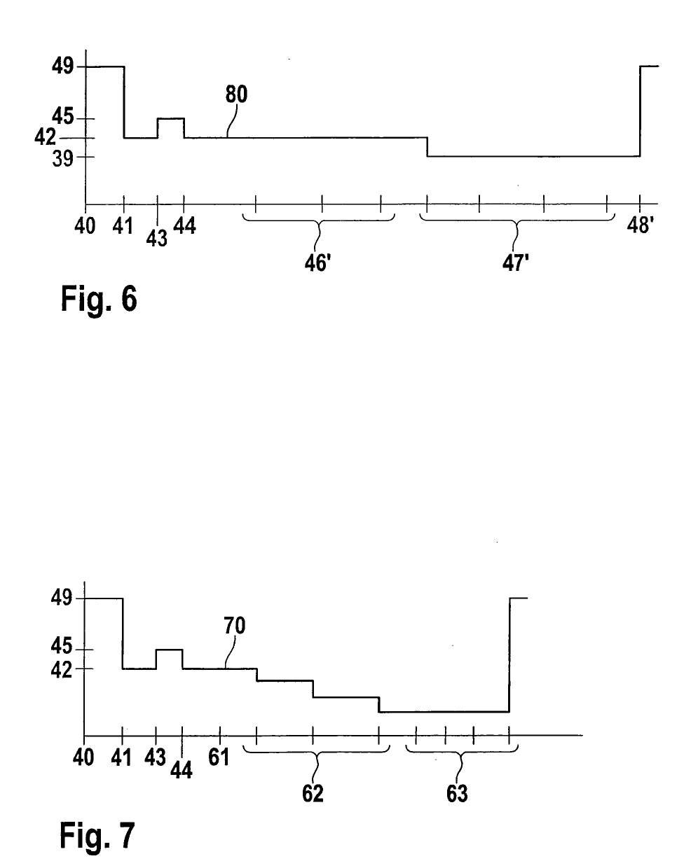

FIG. 6 shows a second mode of the ultrasonic sensor. The mode according to FIG. 6 also shows a course 80 of a threshold value curve. With regard to the threshold values set, threshold value curve 80 corresponds to threshold value curve 50 illustrated in FIG. 4. However, the position in time of the interpolation points has changed. In this case, the position of initial interpolation points 41, 43, 44, which relate to the bottom echo and the decay behavior of the ultrasonic sensor, remains unchanged compared to the threshold value curve shown in FIG. 4. However, subsequent interpolation points 46, 47 each are spaced farther apart in relation to one another and therefore also in relation to zero point 40. Due to the greater interval between interpolation points 46′, 47′, which are otherwise numerically the same, the end of measurement interval 48′ occurs much later. This means that, toward the end of the measurement interval, obstacles may also be detected which are positioned at a greater distance from the ultrasonic sensor than in the case of a measurement according to threshold value curve 50, which already ends at earlier point in time 48.

FIG. 5 shows a further exemplary embodiment having a threshold value curve 60, in which two possible measures are combined with each other. On the one hand, it is possible to shift the position in time of an interpolation point and thus move the time for switching to a different threshold value. While interpolation points having the assigned threshold value (second working value 39) are provided at the same point in time as in FIG. 4, a time 470 for switching the threshold value to second working value 39 is set to a later point in FIG. 5, compared to the threshold value reduction to second working value 39 according to FIG. 4. A further measure is possible by adding additional interpolation points. Thus, is it possible, for example, to provide a newly added interpolation point 51, from which a third working value 52 is reached, at a later point in time. Interpolation points 53, to which second working value 39 is assigned as the threshold value, are provided between interpolation point 470 and interpolation point 51. In this case, it is also possible to achieve a greater range, the measurement ending at an end point 54.

FIG. 7 shows a further exemplary embodiment on the basis of the threshold value curve 70, in which not only the position in time of the interpolation points, but also the threshold value assigned to each of the interpolation points is modified, for example, compared to the embodiment according to FIG. 4. Not only the threshold value curve, but also, if necessary, the duration of the measurement window and the curve of the threshold values during the measurement window are therefore variable. In the case of threshold value curve 70, the threshold value first remains constant at a first interpolation point 61, while it subsequently decreases in multiple stages at subsequent interpolation points 62, and then remains constant again at interpolation points 63. In this case, the position in time of the interpolation points has again varied compared to threshold value curve 50 according to FIG. 4.

An assignment of the position in time of an interpolation point may be implemented, for example, by providing a data field in which the individual entries are assigned to subsequent interpolation points, for example 10 interpolation points. A predefined standard interval may be assigned to these interpolation points. This standard interval is provided in a memory of the ultrasonic sensor. A shift range within which the interpolation point may be moved somewhat forward or somewhat backward is then transmitted in the data field which is transmitted for setting up the interpolation point. The interpolation points may be spaced equidistantly. However, the interval between the interpolation points may also increase as the distance to the ultrasonic sensor increases. This also enables the shift range to be varied. The shift areas around the individual interpolation points may be configured so that overlapping areas of the maximum possible areas occur between adjacent interpolation points, thereby increasing flexibility when setting up the interpolation points.

In a further implementation of the assignment of the position in time of an interpolation point, only the position of the first interpolation point is fixed. All further positions are successively defined by transmitting the time interval between the new and preceding interpolation point. This prevents overlapping of the value ranges of the interpolation point positions. To cover the greatest possible time range, the granularity and the value range of these intervals may be increased by the number of the interpolation point.

Various threshold value curves according to FIGS. 4 through 7 may be stored in the ultrasonic sensor. A control signal may be used to select one of the curves. In a further specific embodiment, however, new interpolation points, or new interpolation points including a corresponding threshold value, may also be transmitted to the ultrasonic sensor.

All interpolation points may also have different threshold values. In the specific embodiment illustrated here, the threshold value is assumed to be constant between two interpolation points. In a further specific embodiment, a linear interpolation takes place between each of two interpolation points, the course of the threshold value curve being assigned to be linear from the threshold value at the first interpolation point to the threshold value at the second interpolation point.

1-10. (canceled)

11. An ultrasonic sensor, comprising:
a time-variable sensitivity arrangement to specify a time-variable sensitivity via threshold values, wherein each threshold value is assigned to one interpolation point, wherein each interpolation point is assigned to one position in time, and wherein the position in time of the interpolation points is variable.

12. The ultrasonic sensor of claim 11, wherein a threshold value is different for different positions in time of particular interpolation points.

13. The ultrasonic sensor of claim 11, wherein the positions in time of the interpolation points are switchable between at least one first state and one second state.

14. The ultrasonic sensor of claim 13, wherein a time interval between the positions in time of at least two interpolation points increases when switched over from the first state to the second state.

15. The ultrasonic sensor of claim 11, further comprising:
a non-volatile memory for storing the positions in time of the interpolation points and the threshold values assigned to the interpolation points.

16. The ultrasonic sensor of claim 11, wherein the position in time is related to a stationary time mark one of at and after an end of a signal transmission.

17. An ultrasonic sensor for measuring a distance for a detection system for objects in surroundings of a motor vehicle, comprising:
a time-variable sensitivity arrangement to specify a time-variable sensitivity via threshold values, wherein each threshold value is assigned to one interpolation point, wherein each interpolation point is assigned to one position in time, and wherein the position in time of the interpolation points is variable.

18. The ultrasonic sensor of claim 17, wherein the measuring of the distance for the objects in the surroundings of the motor vehicle is for use in at least one of a parking aid system, a blind spot warning system and a reversing aid system.

19. An ultrasonic measurement method for measuring distance, the method comprising:
assigning threshold values to interpolation points, which are each assigned a position in time;
specifying a time-variable sensitivity of an ultrasonic sensor via the threshold values; and
varying the position in time of the interpolation points.

20. The ultrasonic measurement method of claim 19, wherein at least one of (i) the threshold values assigned to the interpolation points, and (ii) the positions in time of the interpolation points, are varied by a control signal.

21. The ultrasonic measurement method of claim 19, wherein the position in time assigned to the interpolation points is varied so that one of (i) distances of the interpolation points relative to each other, and (ii) distances of the interpolation points in relation to a fixed distance value, are defined by control signals.
